(19) United States
(12) Patent Application Publication
(10) Pub. No.: US 2013/0159207 A1
(43) Pub. Date: Jun. 20, 2013

(54) IDENTIFYING LOCATION IN PACKAGE AND MAIL DELIVERY SYSTEMS

(71) Applicants: Bryan Don Sears, Longmont, CO (US); Zachary Bryan Sears, Longmont, CO (US)

(72) Inventors: Bryan Don Sears, Longmont, CO (US); Zachary Bryan Sears, Longmont, CO (US)

(21) Appl. No.: 13/329,322

(22) Filed: Dec. 18, 2011

(51) Int. Cl. G06Q 10/08

(52) U.S. Cl. 705/338

(57) ABSTRACT

A system and method of identifying a location in a package and mail delivery system includes inputting a location coordinate into a conversion system having a grid data set, and determining the grid unit that contains the location coordinate. The conversion system divides the Earth's surface into a progressive grid system assigning the position of the location coordinate, and then further dividing the grid into increasingly smaller grid units until a precise identifier is determined for the input location coordinate. The determined identifier for said input location coordinate is output for use in package and mail delivery systems.

### FIELD OF THE INVENTION

The present invention relates to identifying location for a specific delivery destination, more particularly, identifying location for a delivery destination and incorporating the location identifier into the package and mail delivery system to enable the use of location information in the delivery service.

### BACKGROUND OF THE INVENTION

Systems have been developed to deliver packages and mail to a specific destination utilizing street address information. These systems employ mailing address field specifications as established by government, and other, authorities in various countries around the world.

Mailing address fields often include Name, Street address, Street name prefix, Street name, Street name suffix, City, State or Province, and ZIP Code with ZIP+4 or Postal Code, without regard for the specific physical location of the destination property.

Package and mailing address field specifications do not allow for the inclusion of location information that identifies the specific physical location of the delivery destination.

Package and mailing address requirements prevent delivery to places without street address information, including Points of Interest (POI), rural places, and places in undeveloped areas where a structured street addressing system does not exist.

Inclusion of location information in the mailing address fields would cause displacement of the street address information because of the size requirements for containing location coordinate information. This displacement could cause a significant disruption in package and mail delivery services, specifically in areas where a structured street address based delivery service has developed.

No fields exist in package and mail addressing specifications to identify the specific physical location of the delivery destination that can be used by location intelligent delivery services.

Automated package and mail delivery systems are designed to meet the mail address field specifications without the inclusion of destination location information.

Various package and mailing delivery systems are currently available to address, sort, and deliver mail and packages to addressed places. However, packages and mail to unaddressed places and POIs cannot be delivered using postal or package delivery systems because of the lack of location identifying information.

Current methods for identifying location coordinates for a specific physical destination are limited in the package and mail delivery industry because of the number of characters required to represent a location coordinate. Particularly, a standard decimal degree location with an accuracy sufficient to precisely identify the delivery destination minimally requires a 10-character latitude (−90.000000 to 90.000000) and an 11-character longitude (−80.000000 to 180.000000). The required 21-characters are too large to fit into mailing address information fields without displacing the street address data.

Utilizing the ZIP Code and ZIP+4 fields, or Postal Code fields in countries outside of the U.S., will enable the inclusion of location coordinates without displacing the name, street address, city, or state data

The ZIP Code with ZIP+4 and Postal Code fields in package and mail service solutions are limited to 10-characters, (12345-6789). A 10-character representation of the destination location will enable the inclusion of a location coordinate into the mailing address information without displacing the name, street address, city, or state information.

It is, thus, desirable to have an efficient and effective solution that can represent a location coordinate in a 10-character format that can be stored and represented in the ZIP Code with ZIP+4 or Postal Code fields to enable package and mail delivery services to unaddressed destinations and Points of Interest (POI), and to more efficiently provide package and mail delivery services to all destinations.

### SUMMARY OF THE INVENTION

It is an objective of the present invention to provide a method and system to incorporate location information into package and mail delivery systems.

It is a further objective of the present invention to determine a location identifier that represents the geographic coordinate of the delivery location, and that can be used within the limits of package and mail delivery systems.

It is still another objective of the present invention to provide a method to expand package and mail delivery system capabilities beyond those areas that support structured addressing methods.

A method for processing location information to establish a coordinate identifier embodying the present invention includes the steps of entering location coordinate data into the system and accessing a grid data set. A determination is made to identify the grid, in the grid data set, that contains the geographic location coordinate and the grid identifier is output.

A system for identifying the geographic location of a delivery destination embodying the present invention includes a processing system with an input system and an output system. A grid data set is coupled to the processing system.

### BRIEF DESCRIPTION OF THE DRAWINGS

Reference is now made to the various figures wherein like reference numerals designate similar items in the various views and in which:

FIG. 1 is a block diagram of a location conversion system embodying the present invention;

FIG. 2 is a flowchart of the operation of a processing system shown in FIG. 1; and,

FIG. 3 illustrates an example of the operation of a location conversion system of FIG. 1, in accordance with the flow chart in FIG. 2.

### DETAILED DESCRIPTION OF THE PREFERRED EMBODIMENT

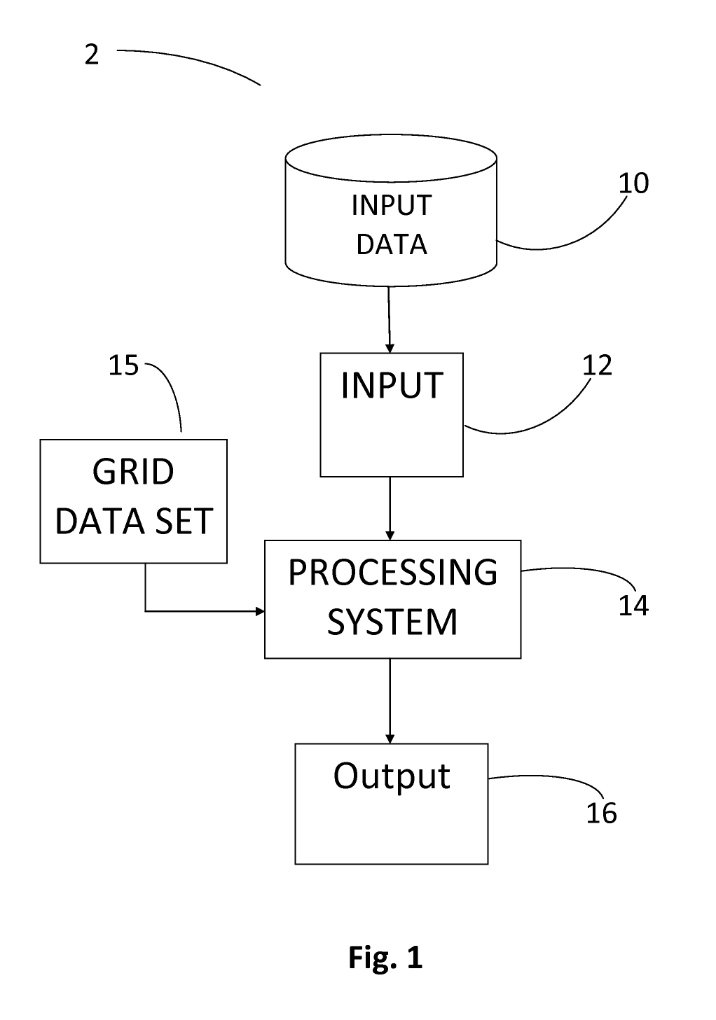

Reference is now made to the various figures and specifically to FIG. 1. A location conversion system 2 includes a processing system 14. An input system 12 is connected to the processing system 14. An output system 16 is also connected to the processing system 14. The input system 12 and output system 16 can be of a wide variety of systems enabling the input and output of data to and from the processing system 14. The processing system 14 processes coordinate data from an input data source 10 and from a grid data set 15. The processing system identifies the grid, from the grid data set 15, which contains the geographic location of the input data 10. The processing system then constructs an identifier for the containing grid unit and outputs the identifier to the output system 16.

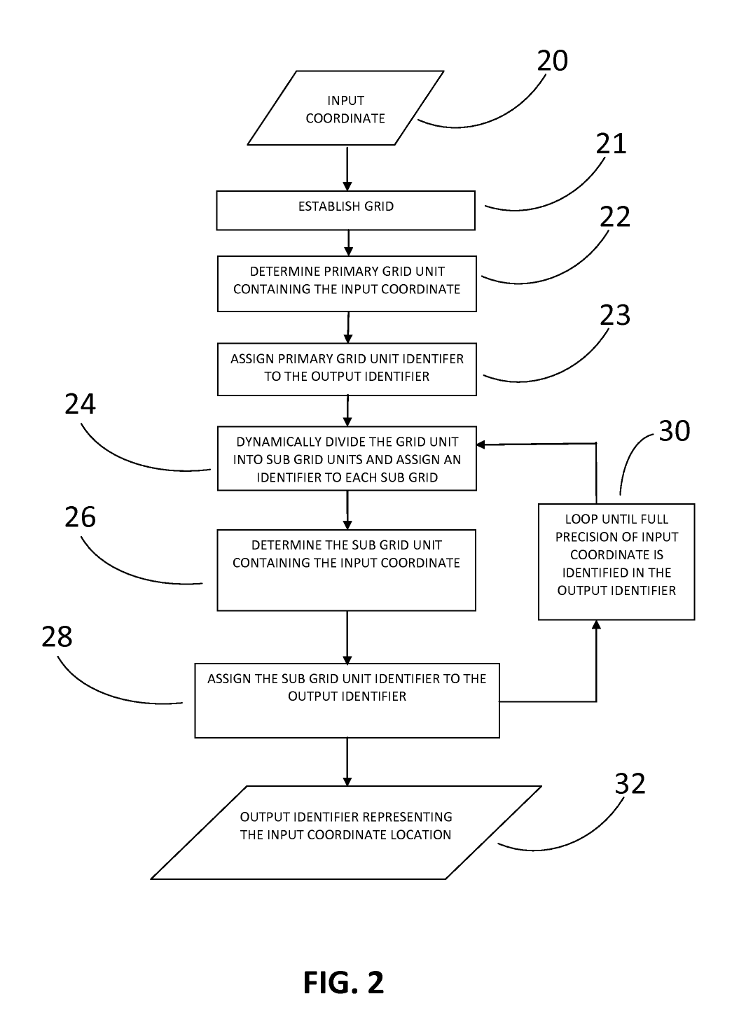

Reference is now made to FIG. 2. An input coordinate is input at block 20. A grid is established 21 and the primary grid unit containing the input coordinate is identified at block 22. The primary grid unit identifier is assigned to the output identifier at block 23. The primary grid unit is further divided into sub grid units, at block 24, and each grid unit is assigned a value. The sub grid unit containing the input coordinate is identified at block 26. The sub grid unit identifier is assigned to the output identifier for the current precision level of the input coordinate at block 28. The operations in blocks 24, 26, and 28 are repeated, block 30, until the location for the full precision of the input coordinate is determined and all input coordinate precision levels are identified in the output identifier. The output identifier, representing the input coordinate location, is output in block 32.

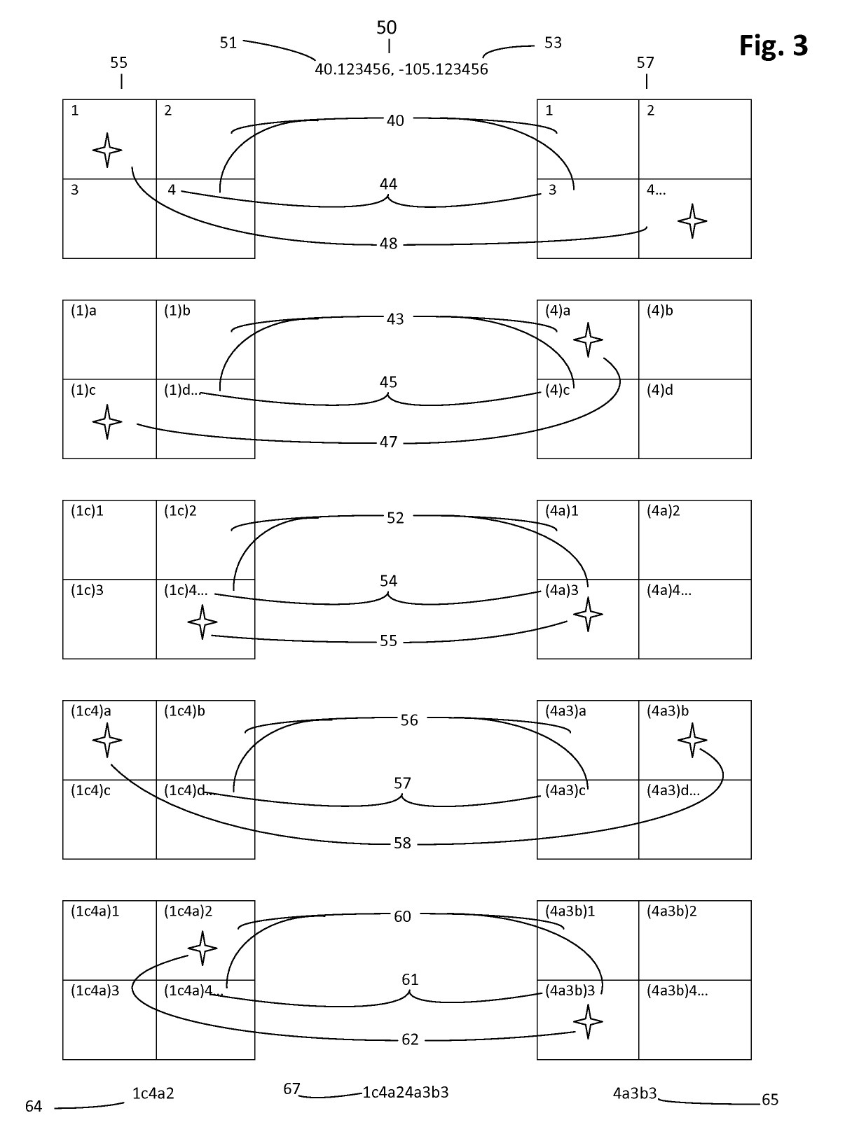

Reference is now made to FIG. 3. First, the grid identifier is determined for the latitude component 51 of the input geographic coordinate 50 as shown in column 55 of FIG. 3. The Earth's surface is divided into sections forming a grid pattern with each grid's size sufficient so that the grid encompasses the Earth's surface. Each grid unit 40 is assigned a value that identifies its grid number 44. The location of the latitude component 51 of the geographic input coordinate 50 is determined to be in one of the grid units 48, in this example the location is within the boundaries of grid unit number one (1), and the grid identifier 44 for the determined grid unit 48 is assigned to the latitude identifier 64 (1).

The grid unit 48 determined to contain the latitude component 51 of the input coordinate 50 is then divided into sub grid units 43 sufficient in size to encompass the whole of the grid unit 48 they divide. The location of the latitude component 51 of the input coordinate 50 is determined to be within one of the sub grid units 47 and the identifier 45 for the determined sub grid unit 47 is assigned to the latitude identifier 64 (1c).

The sub grid unit 47 determined to contain the latitude component 51 of the input coordinate 50 is then divided into further sub grid units 52 sufficient in size to encompass the whole of the sub grid unit 47 they divide. The location of the latitude component 51 of the input coordinate 50 is determined to be within one of the sub grid units 55 and the identifier 54 for the determined sub grid unit 55 is assigned to the latitude identifier 64 (1c4).

The sub grid unit 55 determined to contain the latitude component 51 of the input coordinate 50 is then divided into further sub grid units 56 sufficient in size to encompass the whole of the sub grid unit 55 they divide. The location of the latitude component 51 of the input coordinate 50 is determined to be within one of the sub grid units 58 and the identifier 57 for the determined sub grid unit 58 is assigned to the latitude identifier 64 (1c4a).

The sub grid unit 58 determined to contain the latitude component 51 of the input coordinate 50 is then divided into further sub grid units 60 sufficient in size to encompass the whole of the sub grid unit 58 they divide. The location of the latitude component 51 of the input coordinate 50 is determined to be within one of the sub grid units 62 and the identifier 61 for the determined sub grid unit 62 is assigned to the latitude identifier 64 (1c4a2) completing the 5 characters that represent the latitude identifier 64 in the grid identifier 67.

Still referencing FIG. 3. Secondly, the grid identifier will be determined for the longitude component 53 of the input geographic coordinate 50 as shown in column 57 of FIG. 3. The Earth's surface is divided into sections forming a grid pattern with each grid's size sufficient so that the grid encompasses the Earth's surface. Each grid unit 40 is assigned a value that identifies its grid number 44. The location of the longitude component 53 of the geographic input coordinate 50 is determined to be in one of the grid units 48, in this example the location is within the boundaries of grid unit number four (4), and the grid identifier 44 for the determined grid unit 48 is assigned to the longitude identifier 65 (4).

The grid unit 48 determined to contain the longitude component 53 of the input coordinate 50 is then divided into sub grid units 43 sufficient in size to encompass the whole of the grid unit 48 they divide. The location of the longitude component 53 of the input coordinate 50 is determined to be within one of the sub grid units 47 and the identifier 45 for the determined sub grid unit 47 is assigned to the longitude identifier 65 (4a).

The sub grid unit 47 determined to contain the longitude component 53 of the input coordinate 50 is then divided into further sub grid units 52 sufficient in size to encompass the whole of the sub grid unit 47 they divide. The location of the longitude component 53 of the input coordinate 50 is determined to be within one of the sub grid units 55 and the identifier 54 for the determined sub grid unit 55 is assigned to the longitude identifier 65 (4a3).

The sub grid unit 55 determined to contain the longitude component 53 of the input coordinate 50 is then divided into further sub grid units 56 sufficient in size to encompass the whole of the sub grid unit 55 they divide. The location of the longitude component 53 of the input coordinate 50 is determined to be within one of the sub grid units 58 and the identifier 57 for the determined sub grid unit 58 is assigned to the longitude identifier 65 (4a3b).

The sub grid unit 58 determined to contain the longitude component 53 of the input coordinate 50 is then divided into further sub grid units 60 sufficient in size to encompass the whole of the sub grid unit 58 they divide. The location of the longitude component 53 of the input coordinate 50 is determined to be within one of the sub grid units 62 and the identifier 61 for the determined sub grid unit 62 is assigned to the longitude identifier 65 (4a3b3) completing the 5 characters that represent the longitude identifier 65 in the grid identifier 67.

The grid identifier 67 is output.

While the present invention has been described in connection with what is presently considered to be the most practical and preferred embodiment, it is to be understood that the invention is not limited to the disclosed embodiment, but, on the contrary, is intended to cover various modifications and equivalent arrangements included within the spirit and scope of the appended claims.

What is claimed is:

1. A method for representing geographic coordinates in a package and mail delivery system, comprising the steps of:
entering geographic location data into the system;
establishing a grid encompassing the surface of the Earth;
determining the grid unit in which the geographic coordinate location is contained; and,
creating an identifier that represents the entered geographic location for use within other systems.

2. A method as defined in claim 1 comprising the further steps of stopping said process if the identifier is determined prior to the full precision of the entered geographic location coordinate.

3. A method as defined in claim 1 comprising the steps of developing a grid system that encompasses the Earth's surface and further dividing said grid into smaller sub grids to identify the series of grid units that contain the input geographic location coordinate.

4. A method as defined in claim 1 wherein location identification and output identifier determination is implemented in a single conversion system.

5. A method as defined in claim 1 wherein the output identifier comprised of a character string containing any combination of numerals, alphabetic characters, and special characters to allow a precise identification of said input location.

6. A method as defined in claim 5 wherein the output identifier is comprised of characters from any language.

7. A conversion system comprising:
a processing system;
an input and output system for inputting and outputting data coupled to said processing system;
a grid data set coupled to the processing system;

8. A system as defined in claim 7 wherein said processing system processes retrieved data from said grid data set to formulate a plurality of data for scoring, matching, and identifying the location of said input geographic location data.

9. A system as defined in claim 7 wherein said processing system generates data for said grid data set, as part of said processing, to formulate a plurality of data for scoring, matching, and identifying the location of said input geographic location data.

10. A system as defined in claim 7 wherein said output data is formatted to provide a character string for use as the entirety, or a part of, a package and mail delivery service destination identification.
